(19) United States
(12) Patent Application Publication
(10) Pub. No.: US 2016/0357547 A1
(43) Pub. Date: Dec. 8, 2016

(54) ENGINEERING TOOL PROGRAM AND NETWORK SYSTEM

(71) Applicant: Mitsubishi Electric Corporation, Tokyo (JP)

(72) Inventors: Yusuke MENJO, Tokyo (JP); Shuichi TANAKA, Tokyo (JP); Hideaki IWATA, Tokyo (JP); Yukihiro MAEZAWA, Tokyo (JP)

(73) Assignee: Mitsubishi Electric Corporation, Tokyo (JP)

(21) Appl. No.: 15/101,028

(22) PCT Filed: Dec. 3, 2013
(86) PCT No.: PCT/JP2013/082508

§ 371 Date: Jun. 2, 2016

(51) Int. Cl. G06F 9/445

(52) U.S. Cl. CPC G06F 8/665

(57) ABSTRACT

An engineering tool program, which writes a program to each functional unit of a programmable logic controller, causes a computer connected to the programmable logic controller to perform: an instruction step of instructing each of a plurality of programmable logic controllers to update firmware; and an update step of updating the firmware by writing new firmware to the each functional unit.

### FIELD

The present invention relates to an engineering tool program and a network system that perform an update of firmware of a unit of a programmable logic controller.

### BACKGROUND

A programmable logic controller (PLC) includes a CPU unit, an intelligent functional unit, and the like. An update and the like of firmware of these units are performed manually. Therefore, the update of the firmware requires much time.

In a firmware update system described in Patent Literature 1, a management apparatus is connected to a PLC device via a network. The management apparatus performs an update of firmware with respect to PLCs connected downstream of a core part.

In an information processing system described in Patent Literature 2, a PLC having a master CPU and a plurality of PLCs each having a slave CPU are connected via a system bus. The master CPU rewrites firmware of each of the slave CPUs.

An update jig for firmware described in Patent Literature 3 connects a PC and an update target PLC. The update jig downloads a firmware update file onto the PLC based on the firmware update file transmitted from the PC. At this time, the update jig performs the firmware update with respect to a plurality of PLCs while checking a version of the update file.

### CITATION LIST

### Patent Literatures

Patent Literature 1: Japanese Patent Application Laid-open No. 2006-195766

Patent Literature 2: Japanese Patent Application Laid-open No. 2001-67215

Patent Literature 3: Japanese Patent Application Laid-open No. 2012-3658

### SUMMARY

### Technical Problem

However, in the cases of the first and second conventional techniques described above, a PC and a management PLC for updating firmware are required. Then, the firmware is updated with respect to the PLC managed by the management PLC. Accordingly, there is a problem that a system configuration becomes complicated. In the case of the third conventional technique described above, it is necessary to attach the update jig to the system, which causes a problem that a system configuration becomes complicated.

The present invention has been achieved in view of the above problems, and an object of the present invention is to provide an engineering tool program, a network system, and a programmable logic controller that can update plural pieces of firmware with a simple configuration.

### Solution to Problem

To solve the above-mentioned problems and achieve the object, the present invention provides an engineering tool program that writes a program to each functional unit of a programmable logic controller. The engineering tool program is characterized by causing a computer connected to the programmable logic controller to perform: an instruction step of instructing each of a plurality of programmable logic controllers to update firmware; and an update step of updating the firmware by writing new firmware to the each functional unit.

### ADVANTAGEOUS EFFECTS OF INVENTION

According to the present invention, it is possible to update plural pieces of firmware with a simple configuration.

### BRIEF DESCRIPTION OF DRAWINGS

FIG. 1 is a diagram illustrating a configuration of a network system according to an embodiment of the present invention.

FIG. 2 is a diagram illustrating a configuration example of a PLC.

FIG. 3 is a flowchart illustrating a process procedure performed by a PC when starting an update of firmware with respect to one unit.

FIG. 4 is a flowchart illustrating a process procedure of a firmware update process with respect to one unit.

FIG. 5 is a flowchart illustrating a process procedure performed by a network system when starting an update of firmware with respect to a plurality of units.

FIG. 6 is a flowchart illustrating a process procedure of a firmware update process with respect to a plurality of units.

FIG. 7 is a diagram illustrating a hardware configuration of a PC.

### DESCRIPTION OF EMBODIMENTS

Exemplary embodiments of an engineering tool program and a network system according to the present invention will be described below in detail with reference to the accompanying drawings. The present invention is not limited to the embodiments.

### Embodiment

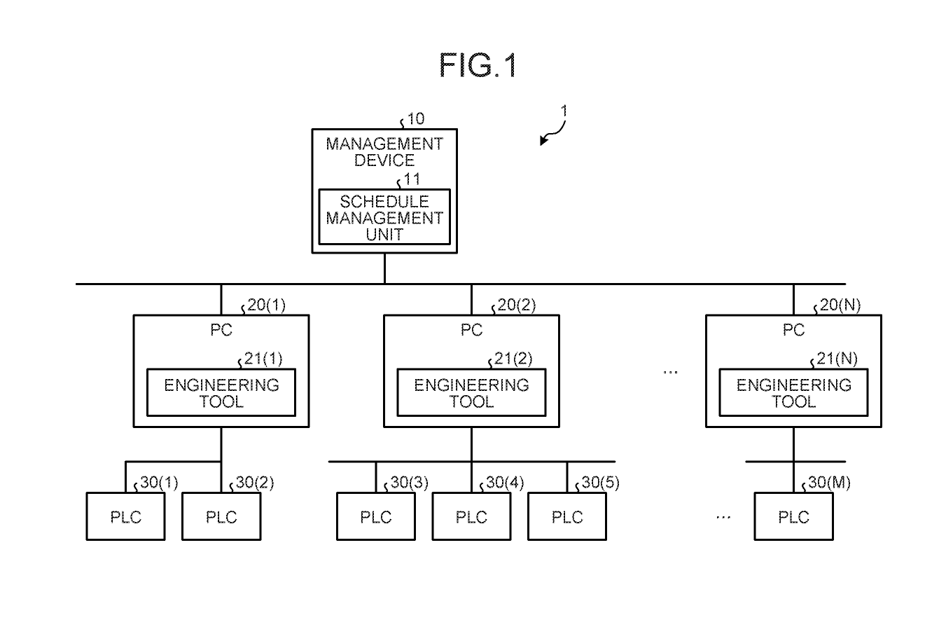

FIG. 1 is a diagram illustrating a configuration of a network system according to an embodiment of the present invention. A network system 1 according to the present embodiment is a system that automatically performs an update with respect to firmware of a unit (functional unit) included in a PLC (programmable logic controller).

The network system 1 has a management device (a production management apparatus) 10, PCs (Personal Computers) 20 (1) to 20 (N), and PLCs 30 (1) to 30(M). Here, M and N are natural numbers equal to or larger than 2.

In the network system 1, each of the PCs 20(1) to 20(N) is connected to the management device 10 through a network. Moreover, each of the PCs 20(1) to 20(N) is connected to the PLC to be managed thereby. This example illustrates a case where the PLCs 30(1) and 30(2) are connected to the PC 20(1), the PLCs 30(3) to 30(5) are connected to the PC 20(2), and the PLC 30(M) is connected to the PC 20(N). Therefore, the PC 20(1) manages the PLCs 30(1) and 30(2), the PC 20(2) manages the PLCs 30(3) to 30(5), and the PC 20(N) manages the PLC 30(M).

It should be noted that in the following description, any one or plural pieces of the PCs 20(1) to 20(N) may be simply referred to as PC 20. Any one or plural pieces of the PLCs 20(1) to 20(M) may also be simply referred to as PLC 30.

The PCs 20(1) to 20(N) have engineering tools 21(1) to 21(N), respectively. The engineering tools 21(1) to 21(N) each is a tool (system setting program) that executes control on the PLC 30. The engineering tools 21(1) to 21(N) are software for writing, to the PLCs 30(1) to 30(M), programs (such as firmware) that cause the PLCs 30(1) to 30(M) to operate, respectively.

In other words, the engineering tools 21(1) to 21(N) are tools for programming ways to operate the PLCs 30(1) to 30(M). The engineering tools 21(1) to 21(N) are recorded in a non-transitory computer readable recording medium or the like.

Each of the engineering tools 21(1) to 21(N) according to the present embodiment has a function of updating firmware included in the PLC 30. It should be noted that in the following description, any one or plural pieces of the engineering tools 21(1) to 21(N) may be simply referred to as engineering tool 21.

The management device 10 is a computer or the like that controls the PCs 20. The management device 10 has a schedule management unit 11 that performs schedule management of a production process. The schedule management unit 11 memorizes a boot order (startup order) of the PLCs 30 installed at respective places and operation schedules (production plans) of the respective PLCs 30. The production processes whose schedule is managed by the schedule management unit 11 are performed by utilizing the PLCs 30.

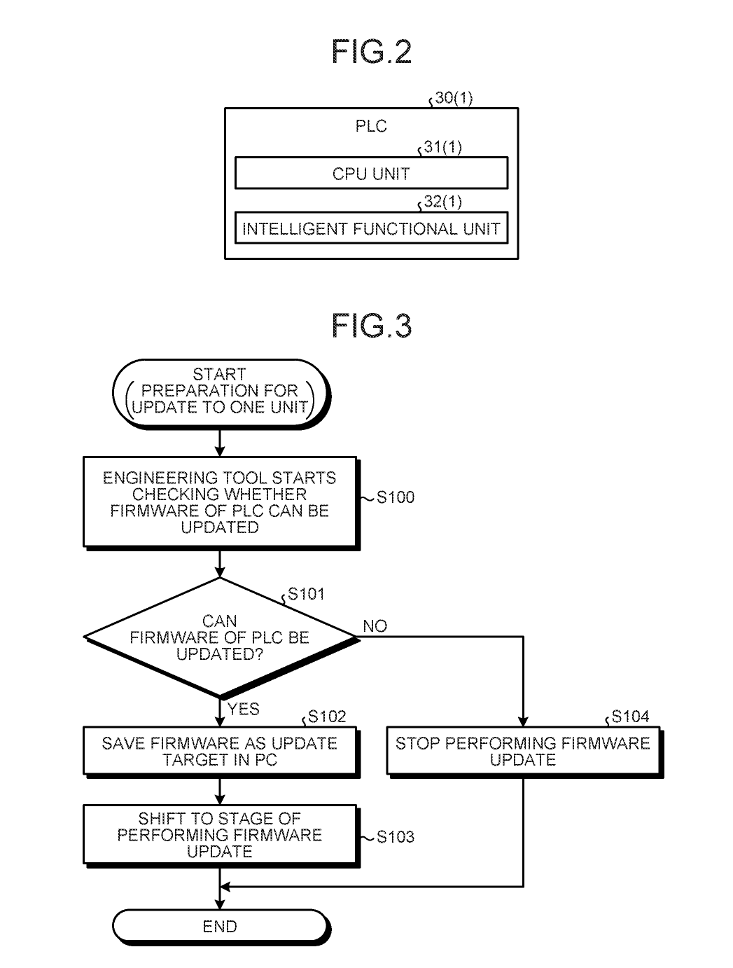

A configuration example of the PLC 30 is described below. Note that the PLCs 30(1) to 30(M) have the same configuration, and therefore a configuration of the PLC 30(1) is described here. FIG. 2 is a diagram illustrating a configuration example of the PLC. The PLC 30(1) has a CPU unit 31(1) and an intelligent functional unit 32(1).

The CPU unit 31(1) controls the PLC 30(1). When receiving an instruction of a firmware update from the engineering tool 21(1), the CPU unit 31(1) receives firmware for the update from the engineering tool 21(1). Upon reception of the firmware for the update, the CPU unit 31(1) updates the firmware included in the CPU unit 31(1).

The intelligent functional unit 32(1) is a unit having a function other than input/output, such as an A/D conversion (Analog/Digital Conversion) unit and a D/A conversion (Digital/Analog Conversion) unit. When receiving an instruction of a firmware update from the engineering tool 21(1), the intelligent functional unit 32(1) receives firmware for the update from the engineering tool 21(1). Upon reception of the firmware for the update, the intelligent functional unit 32(1) updates the firmware included in the intelligent functional unit 32(1).

Similarly, the PLCs 30(2) to 30(M) have CPU units 31(2) to 31(M) (not illustrated) and intelligent functional units 32(2) to 32(M) (not illustrated), respectively. The CPU units 31(2) to 31(M) each has the same function as that of the CPU unit 31(1), and the intelligent functional units 32(2) to 32(M) each has the same function as that of the intelligent functional unit 32(1). It should be noted that in the following description, any one or plural pieces of the CPU units 31(1) to 31(M) may be simply referred to as CPU unit 31. Any one or plural pieces of the intelligent functional units 32(1) to 32(M) may also be simply referred to as intelligent functional unit 32.

Next, an operation of the PC 20 in a case where one PC 20 starts an update of the firmware with respect to one unit is described. FIG. 3 is a flowchart illustrating a process procedure performed by the PC when starting the update of the firmware with respect to one unit. FIG. 3 shows a procedure (a preparation procedure before starting of execution of the update) performed by the engineering tool 21(1) to check whether or not the firmware of the PLC 30(1) that is under management of the engineering tool 21(1) can be updated (the version thereof can be upgraded).

The engineering tool 21(1) of the PC 20(1) starts checking whether or not the firmware can be updated with respect to one unit of the PLC 30(1) that is under management thereof (Step S100).

At this time, the engineering tool 21(1) accesses the unit being a check target and acquires a firmware version from the unit. Then, the engineering tool 21(1) checks, based on the acquired firmware version, whether or not the firmware of the unit being the check target can be updated (whether or not the unit is an update target) (Step S101). The unit to which the firmware update is performed is, for example, the CPU unit 31(1) or the intelligent functional unit 32(1).

If the acquired firmware version is older than that of firmware used for the update, the engineering tool 21(1) determines that the firmware of the PLC 30(1) can be updated.

When determining that the firmware of the PLC 30(1) can be updated (YES at Step S101), the engineering tool 21(1) stores, in the PC 20 in which the engineering tool 21(1) is installed, firmware used for the update and stored in an external device and the like (Step S102). Then, the engineering tool 21(1) shifts to a stage of performing the firmware update (Step S103). It should be noted that the firmware used for the update can be stored in the PC 20 at any timing as long as it is before execution of the firmware update.

On the other hand, when determining that the firmware of the PLC 30(1) cannot be updated (NO at Step S101), the engineering tool 21(1) cancels performing the firmware update (Step S104).

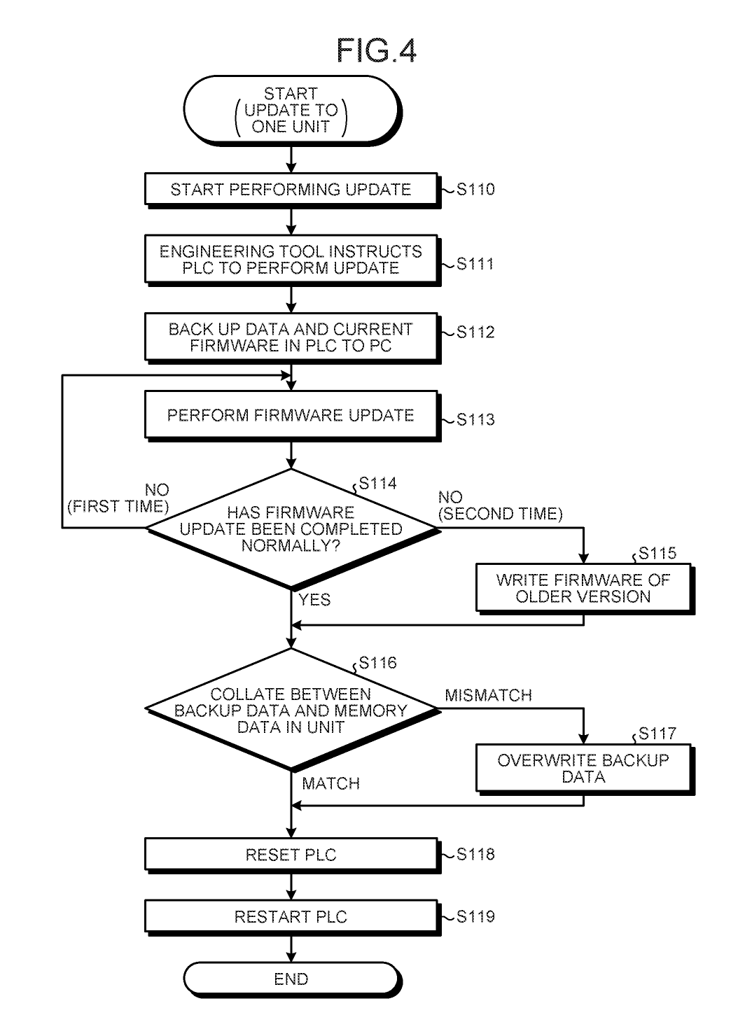

Next, a process of performing the firmware update is described. FIG. 4 is a flowchart illustrating a process procedure of the firmware update process with respect to one unit. FIG. 4 shows a process procedure where the engineering tool 21(1) performs the firmware update with respect to one unit (the CPU unit 31(1), for example) and then the update is completed.

When the engineering tool 21(1) shifts to the stage of performing the firmware update (after Step S103 in FIG. 3), the engineering tool 21(1) starts performing the firmware update (Step S110).

The engineering tool 21(1) instructs the PLC 30(1) to perform an update of one unit (the CPU unit 31(1)) (Step S111). This instruction to perform the update is transmitted from the engineering tool 21(1) to the unit being the update target.

The PC 20(1) reads, from the PLC 30(1) as the update target, data (such as programs and parameters) and the current firmware in the PLC 30(1) to back up the data and the firmware (Step S112).

More specifically, the engineering tool 21(1) outputs a backup instruction to the CPU unit 31(1) of the PLC 30(1). Upon reception of the instruction, the CPU unit 31(1) causes the PC 20(1) to back up the programs, the parameters, and the current firmware data in the PLC 30(1).

After the backup is completed, the engineering tool 21(1) writes the previously-stored new firmware to the CPU unit 31(1) of the PLC 30(1). In this manner, the update of the firmware is performed (Step S113). The new firmware written to the CPU unit 31(1) is, for example, firmware obtained by incorporating a new function into the firmware having been installed in the CPU unit 31(1).

The engineering tool 21(1) may write firmware of an older version to the CPU unit 31(1). In other words, changing to the new firmware can be downgrading. In view of the above, the engineering tool 21(1) performs upgrading or downgrading of the firmware as the firmware update process with respect to the CPU unit 31(1). Hereinafter, the case where the engineering tool 21(1) performs upgrading of the firmware with respect to the CPU unit 31(1) will be described.

The CPU unit 31(1) to which the update has been performed self-checks whether or not the firmware update has been completed normally (Step S114). The CPU unit 31(1) notifies the engineering tool 21(1) of a result of the check.

If the update has not been completed normally (NO (the first time) at Step S114), the engineering tool 21(1) writes the previously-stored new firmware to the CPU unit 31(1) of the PLC 30(1). In this manner, the update of the firmware is performed (Step S113).

Then, the CPU unit 31(1) to which the update has been performed self-checks whether or not the firmware update has been completed normally (Step S114). The CPU unit 31(1) notifies the engineering tool 21(1) of a result of the check.

If the update has not been completed normally again (NO (the second time) at Step S114), the engineering tool 21(1) writes the backed-up firmware of the older version to the CPU unit 31(1) of the PLC 30(1) (Step S115).

In other words, if the update is not completed normally for two times, the firmware of the older version is restored (reset) in the CPU unit 31(1). Accordingly, the firmware of the older version is written back to the CPU unit 31(1).

The engineering tool 21(1) performs collation between data (the programs and the parameters) stored in a memory of the updated CPU unit 31(1) and data (backup data) previously backed up in the PC 20(1) (Step S116).

If the update has been completed normally (YES at Step S114), the engineering tool 21(1) performs collation between data (the programs and the parameters) stored in the memory of the updated CPU unit 31(1) and the data (backup data) previously backed up in the PC 20(1) (Step S116).

In this manner, when the update with the firmware of the new version or the write-back of the firmware of the older version is completed, comparison between the data in the CPU unit 31(1) and the data backed up in the PC 20(1) is performed.

The engineering tool 21(1) checks, through the data comparison, whether the both data match or not. When the data does not match (mismatch at Step S116), the engineering tool 21(1) overwrites the memory data in the CPU unit 31(1) with the data previously backed up in the PC 20(1) (Step S117). In other words, when the firmware is updated with the new firmware, the memory data in the CPU unit 31(1) is overwritten with the programs and the parameters previously backed up in the PC 20(1).

In this manner, the engineering tool 21(1) brings the programs and parameters after the firmware update in line with the programs and parameters obtained before the firmware update. Subsequently, the engineering tool 21(1) resets the PLC 30(1) (Step S118).

If it is confirmed through the data comparison that the both data match (match at Step S116), the engineering tool 21(1) resets the PLC 30(1) (Step S118). After resetting the PLC 30(1), the engineering tool 21(1) restarts the PLC 30(1) to complete the update (Step S119).

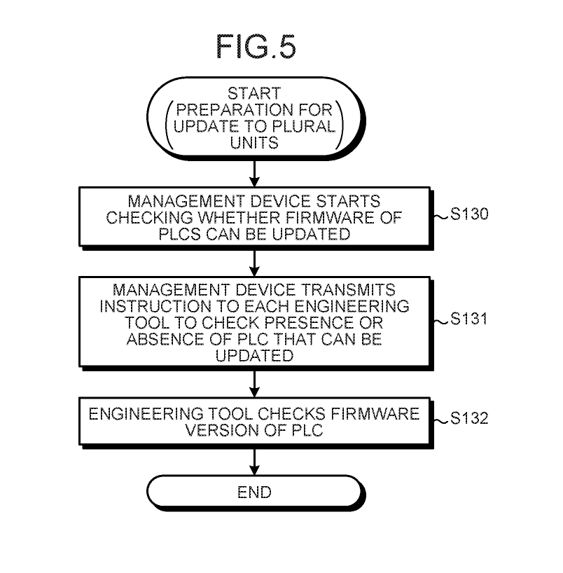

Next, a process in a case where an update is performed with respect to each of units included in a plurality of PLCs is described. FIG. 5 is a flowchart illustrating a process procedure performed by the network system when starting an update of firmware with respect to a plurality of units. FIG. 5 shows a procedure (a preparation procedure before starting of execution of the update) performed by the schedule management unit 11 and the engineering tool 21 to check whether or not the firmware update can be performed with respect to the PLCs in the entire network system 1.

The schedule management unit 11 of the management device 10 starts checking whether or not the firmware update can be performed with respect to each of the plurality of units in the PLCs 30 that are under management thereof (Step S130). The schedule management unit 11 selects a model (a type name) of units to be updated, based on a production plan or the like.

Subsequently, the schedule management unit 11 notifies the PCs 20 in which the engineering tools 21 are installed of the model of the units to be updated. Furthermore, the schedule management unit 11 checks whether or not update is necessary for the firmware of the selected units. More specifically, the schedule management unit 11 transmits, to each of the engineering tools 21 that manage the selected units, an instruction of checking presence or absence of a PLC (a unit) that can be updated (Step S131).

As a result, the engineering tool 21 that has received the instruction checks a version of the firmware of each of the selected units (Step S132). More specifically, the engineering tool 21 instructs the selected units to check the version of the firmware. Accordingly, the unit that has received the instruction transmits the version of the firmware to the corresponding engineering tool 21. The engineering tool 21 receives the version of the firmware from each of the selected units to check the version of the firmware of each of the selected units.

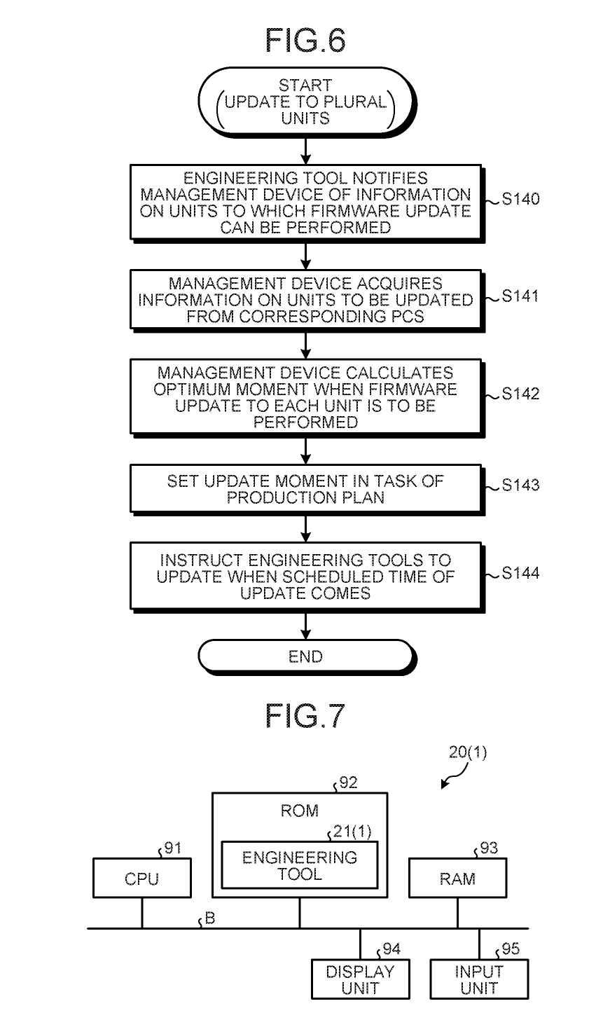

After the version of the firmware of each of the units is checked, the process as shown in FIG. 3 (Steps S100 to S104) is performed in the network system 1 with respect to each of the selected units. When the process up to Step S104 is completed for all the units, a process described below and illustrated in FIG. 6 is started.

FIG. 6 is a flowchart illustrating a process procedure of a firmware update process with respect to a plurality of units. In the network system 1, the schedule management unit 11 collects, from the engineering tools 21, information on the units to which the firmware update is performed. Then, the schedule management unit 11 calculates a time required for the update in the entire network system 1 and an optimum timing for the update, and issues, based on the calculated time and timing, an update instruction to each of the engineering tools 21.

More specifically, the schedule management unit 11 requests information related to the firmware update target units to each of the engineering tools 21 that manages the firmware update target units.

Each of the engineering tools 21 transmits, to the schedule management unit 11, information corresponding to the request from the schedule management unit 11. Each of the engineering tools 21 notifies the schedule management unit 11 of information on units to which the firmware update can be performed among the units requested by the schedule management unit 11 (Step S140). As a result, the schedule management unit 11 acquires, from each of the engineering tools 21 of each of the PCs 20, information on the units that can be updated (Step S141).

The schedule management unit 11 beforehand memorizes, as update information, information on a time required for updating the firmware of each of the units and information on an order (startup order) of resetting the PLCs 30. The schedule management unit 11 calculates, as an update total time, a sum of a time required for updating the firmware of all the units being the update targets and a time required until the network system 1 becomes ready. The schedule management unit 11 calculates the update total time based on the update information.

The update total time is a time from when the update of the first firmware among the firmware of all the units being the update targets is started until when the network system 1 becomes ready.

The schedule management unit 11 uses the update information to calculate an optimum moment (timing) when the firmware of each of the units is to be updated (Step S142). Based on an operation schedule (a production plan) of each of the PLCs 30, the schedule management unit 11 sets a timing (an update timing) of updating the firmware at a time period when the production process by the network system 1 is not interrupted (such as a vacant time in a production plan schedule). The time period when the production process by the network system 1 is not interrupted is, for example, a time period when the PLCs 30 are not working.

The schedule management unit 11 sets the set update timing in a task of the production plan (the production process) (Step S143). When a scheduled time for the update comes, the schedule management unit 11 issues, to the engineering tools 21 in turn, an instruction of updating to each of the units (Step S144).

Each of the engineering tools 21 that has received the update instruction from the schedule management unit 11 performs the update of each of the units according to the process procedure described in FIG. 4. When the update is completed for all the units, the schedule management unit 11 resets each of the PLCs 30 according to the update information.

FIG. 7 is a diagram illustrating a hardware configuration of the PC. Since the PCs 20(1) to 20(N) have the same configuration, a configuration of the PC 20(1) is described here. The PC 20(1) has a CPU (Central Processing Unit) 91, a ROM (Read Only Memory) 92, a RAM (Random Access Memory) 93, a display unit 94, and an input unit 95. In the PC 20(1), the CPU 91, the ROM 92, the RAM 93, the display unit 94, and the input unit 95 are connected via a bus line B.

The CPU 91 uses the engineering tool 21(1) being a computer program (engineering tool program) to write, to the PLC 30(1), a program for operating the PLC 30(1).

The display unit 94 is a display device such as a liquid crystal monitor, and displays the version of firmware and the like of each of the units included in the PLC 30(1) in accordance with an instruction from the CPU 91. The input unit 95 is configured to include a mouse and a keyboard, and instruction information (such as parameters required for updating the firmware) is externally input by a user to the input unit 95. The instruction information input to the input unit 95 is transmitted to the CPU 91.

The engineering tool 21(1) is stored in the ROM 92 and loaded to the RAM 93 via the bus line B. The CPU 91 executes the engineering tool 21(1) loaded in the RAM 93. More specifically, in the PC 20(1), according to an instruction input by the user through the input unit 95, the CPU 91 reads the engineering tool 21(1) from the ROM 92 and loads the engineering tool 21(1) to a program storage area in the RAM 93 to perform various processes. The CPU 91 temporarily stores various types of data generated by the various processes in a data storage area formed in the RAM 93.

The engineering tool 21(1) to be executed in the PC 20(1) is loaded on a main memory, when a program (such as firmware) for operating the PLC 30(1) is written to the PLC 30(1) or when the firmware is to be updated, and these data are generated on the main memory.

It should be noted that when the update has not been completed normally, the schedule management unit 11 may modify the production plan. In this case, the engineering tool 21 calculates a time required for recovery of the unit to which the update has not been completed normally, and transmits the calculated time to the schedule management unit 11. Accordingly, the schedule management unit 11 automatically modifies the production plan based on the time required for recovery.

In the network system 1, computers other than the PCs 20 may be provided instead of the PCs 20. Furthermore, the number of PC 20 provided in the network system 1 is not limited to plural but can be one.

According to the present embodiment, as described above, the firmware of each of the units included in the PLCs 30 is automatically updated. The schedule management unit 11 performs the update in the vacant time of the production plan schedule. Therefore, the working hours of workers can be shortened, and delays in the production process can be eliminated.

Moreover, the schedule management unit 11 calculates the optimum timing for updating each firmware, based on the information on the order of resetting the PLCs 30. It is therefore possible to smoothly establish a factory or the like to which the network system 1 is applied.

Furthermore, according to the present embodiment, data (such as the programs and the parameters) of the PLC 30 is automatically backed up before the update of the firmware, and the backed-up data is set in the new firmware after the update. It is therefore possible to avoid inconsistent operations before and after the update.

Furthermore, according to the present embodiment, the PC 20 updates the firmware in the unit included in the PLC 30. It is therefore possible to update the firmware without using a special jig (interface device).

Moreover, since the PC 20 updates the firmware, it is possible to set whether to perform the update with respect to each of the units. Furthermore, since the production plan is modified if the update is not completed normally, it is possible to perform an efficient production.

As described above, according to the present embodiment, the engineering tool 21 in the PC 20 updates the firmware in each of the plurality of units included in the PLCs 30. It is thus possible to update plural pieces of firmware with a simple configuration.

Moreover, the timing of updating the firmware is set at a time period when the production process is not interrupted. It is thus possible to update the firmware of the unit included in the PLCs 30 without changing the production process.

### INDUSTRIAL APPLICABILITY

As described above, the engineering tool program and the network system according to the present invention are suitable for updating the firmware.

### REFERENCE SIGNS LIST

1 network system,
10 management device,
11 schedule management unit,
20(1) to 20(N) PC,
21(1) to 21(N) engineering tool,
30(1) to 30(M) PLC,
31(1) CPU unit,
32(1) intelligent functional unit.

1. A non-transitory recording medium which stores an engineering tool program that writes a program to each functional unit of a programmable logic controller,
the engineering tool program causing a computer connected to the programmable logic controller to perform:
an instruction step of instructing each of a plurality of programmable logic controllers to update firmware; and
an update step of updating the firmware by writing new firmware to the each functional unit.

2. The non-transitory recording medium according to claim 1,
wherein the engineering tool program causes the computer to perform a process of instructing the update of the firmware and a process of updating the firmware with respect to each functional unit in an order of starting the programmable logic controllers.

3. The non-transitory recording medium according to claim 1,
wherein the engineering tool program causes the computer to further perform a determination step of determining, based on a plan of production performed by the programmable logic controller, a timing at which the programmable logic controller is not working, and
the engineering tool program causes the computer to perform, at the timing, a process of instructing the update of the firmware and a process of updating the firmware.

4. The non-transitory recording medium according to claim 1,
wherein the engineering tool program causes causing the computer to further perform:
a first backup step of backing up, before updating the firmware, a program and a parameter set in the functional unit; and
a reset step of resetting, after the firmware is updated normally, the backed-up program and parameter in the functional unit.

5. The non-transitory recording medium according to claim 1,
wherein the engineering tool program causes the computer to further perform:
a second backup step of backing up, before starting updating the firmware, older firmware being the firmware before the update; and
a restore step of writing back, if the update of the firmware is not completed normally, the older firmware to a unit to which the update is not completed normally.

6. A network system comprising:
a plurality of programmable logic controllers; and
a computer connected to the plurality of programmable logic controllers and controlling the plurality of programmable logic controllers, wherein
each of the programmable logic controllers has a functional unit, and
the computer updates firmware of each functional unit by using an engineering tool program for writing a program to the functional unit.

7. The network system according to claim 6, further comprising a management device that controls the computer and sets a plan of production utilizing the programmable logic controllers, wherein
the computer backs up, before starting updating the firmware, older firmware being the firmware before the update,
the computer writes back, if the update of the firmware is not completed normally, the older firmware to a unit to which the update is not completed normally, and
the management device resets the plan of production based on a time required for recovery of the unit to which the update is not completed normally.

8. The network system according to claim 7, wherein
the functional unit determines whether or not the update of the firmware is completed normally and notifies the computer of a determination result, and
the computer writes back, when receiving from the functional unit a notification that the update of the firmware is not completed normally, the older firmware to the unit to which the update is not completed normally.
